(19) United States
(12) Patent Application Publication
(10) Pub. No.: US 2024/0253615 A1
(43) Pub. Date: Aug. 1, 2024

(54) HYBRID DRIVE UNIT, HYBRID DRIVE ARRANGEMENT AND METHOD FOR OPERATING A HYBRID DRIVE ARRANGEMENT

(71) Applicant: Schaeffler Technologies AG & Co. KG, Herzogenaurach (DE)

(72) Inventors: Ralf Mannsperger, Renchen (DE); Timo Enders, Bensheim (DE)

(73) Assignee: Schaeffler Technologies AG & Co. KG, Herzogenaurach (DE)

(21) Appl. No.: 17/292,908

(22) PCT Filed: Nov. 4, 2019
(86) PCT No.: PCT/DE2019/100945

§ 371 Date: Sep. 21, 2021

(30) Foreign Application Priority Data
Nov. 12, 2018 (DE) 102018128159.5

(51) Int. Cl. B60W 20/40; B60K 6/26; B60K 6/38; B60K 6/40

(52) U.S. Cl. CPC B60W 20/40; B60K 6/26; B60K 6/38; B60K 6/40; B60Y 2200/92

(57) ABSTRACT

The invention relates to a hybrid drive unit for a drive train of an electrically drivable motor vehicle, a hybrid drive arrangement comprising a hybrid drive unit according to the invention and a method for operating a hybrid drive arrangement according to the invention.

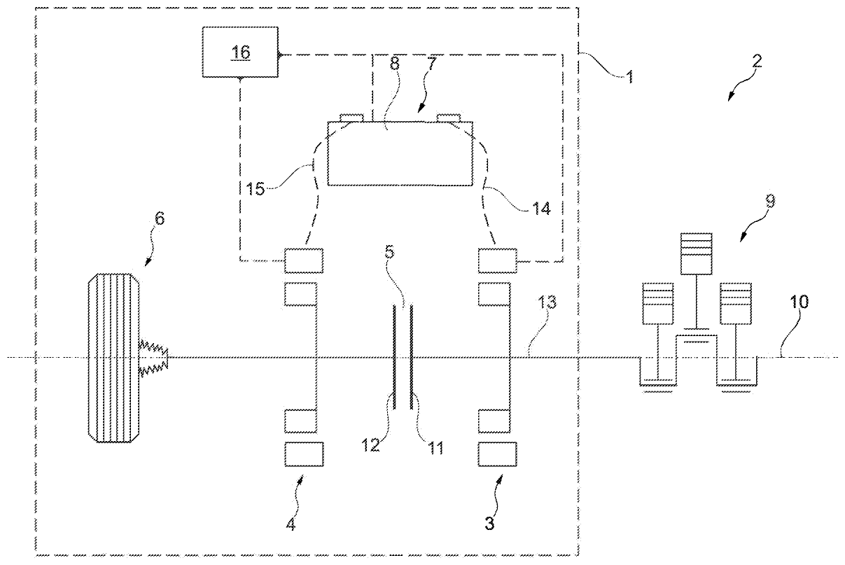

A hybrid drive unit (1) comprises a connection device (13) for mechanically coupling an internal combustion engine (9), a first electrical machine (3), a disconnect clutch (5), a second electrical machine (4), an output device (6), and an electrical line system (7) as well as a control device (16) which is designed to operate the second electrical machine (4) in generator mode, to supply electrical energy provided by the second electrical machine (4) to the electrical line system (7), and to supply electrical energy from the electrical line system (7) to the first electrical machine (3) and to operate it in motor mode.

By means of the design of the proposed hybrid drive unit, hybrid drive arrangement and method according to the invention, the individual elements of the hybrid drive unit according to the invention can be used efficiently, in particular with multiple functions, so as to achieve optimal driving with a comfortable and reliable driving feel.

### CROSS-REFERENCE TO RELATED APPLICATIONS

This application is the U.S. National Phase of PCT Appln. No. PCT/DE2019/100945 filed Nov. 4, 2019, which claims priority to DE 102018128159.5 filed Nov. 12, 2019, the entire disclosures of which are incorporated by reference herein.

### TECHNICAL FIELD

The disclosure relates to a hybrid drive unit for a drive train of an electrically drivable motor vehicle, in particular a hybrid motor vehicle, and a hybrid drive arrangement of an electrically drivable motor vehicle, in particular a hybrid motor vehicle, comprising a hybrid drive unit according to the disclosure.

In addition, the disclosure also relates to a method for operating a hybrid drive arrangement.

### BACKGROUND

Hybrid drive units having an electrical machine, an output device, and an electrical storage device are known from the prior art. The output device can, for example, be a vehicle wheel of a motor vehicle and can be securely connected to the electrical machine. The electrical machine is designed to be operated in generator mode, for example when driving downhill, driven by the torque of the output device, and to generate electrical energy. The generated electrical energy is sent to the electrical storage device for storage. Hybrid drive units configured in this way can use the drag torque of the electrical machine in generator mode as braking torque in order to reduce the speed of the output device, for example to bring a vehicle wheel to a standstill or to slow down the vehicle.

However, this effect can only be used advantageously if the electrical storage device has capacity for electrical energy so as to absorb the electrical energy generated by the electrical machine.

A motor vehicle with a hybrid drive unit according to the prior art also typically comprises a mechanical braking device.

In a driving situation, such as a deceleration situation, in particular downhill travel or in city traffic, if the electrical storage device can no longer receive electrical energy, the mechanical braking device is used so as to replace or supplement the drag torque of the electrical machine used as braking torque in generator mode.

The change between the drag torque of the electrical machine and the engagement of the mechanical braking device is usually perceived as uncomfortable by the driver of the motor vehicle.

Furthermore, in the driving situation of downhill travel, the motor vehicle may experience an unwanted acceleration at least temporarily after a failure of the drag torque of the electrical machine, for example when the braking torque changes as mentioned above, which can give the impression of uncontrolled downhill rolling to the driver.

Furthermore, US 2013/0029805 A1 discloses a hybrid drive arrangement having an internal combustion engine, an electrical machine, and a disconnect clutch, as well as a speed sensor and a control device which is designed to open or close the disconnect clutch as a function of the desired speed ratios.

However, the number of drive machines imposes limits on the number of operating modes of the hybrid drive arrangement.

### SUMMARY

On this basis, the object of the present disclosure is to provide a hybrid drive unit and hybrid drive arrangements equipped therewith and a method for operating such a hybrid arrangement which, in a simple manner through efficient use of the elements of the hybrid drive unit according to the disclosure, combines optimum driving operation with a comfortable and reliable driving feel.

The object is achieved by the hybrid drive unit, the hybrid drive arrangement and the method for operating a hybrid drive arrangement described herein. Advantageous embodiments of the hybrid drive unit are described herein and in the accompanying claims.

In addition, the features of the claims may be combined in any technically useful way, including the explanations given in the following description and features of the figures can be used which comprise additional embodiments of the disclosure.

The disclosure relates to a hybrid drive unit for a drive train of an electrically drivable motor vehicle, in particular a hybrid motor vehicle, having a connection device for mechanically coupling an internal combustion engine, a first electrical machine, a disconnect clutch, a second electrical machine, an output device and an electrical conduction system between the first electrical machine and the second electrical machine. Furthermore, the hybrid drive unit comprises a control device which is designed to operate the second electrical machine in generator mode when a braking torque is required on the output device, to supply electrical energy provided by the second electrical machine to the electrical line system and to supply electrical energy from the electrical line system of the first electrical machine and operate it, while making at least proportional use of the electrical energy from the electrical line system in motor mode. In this way, the second electrical machine drives the connection device, with which torque can then be supplied to the internal combustion engine.

The amount of electrical energy supplied to the second electrical machine from the electrical line system corresponds at least proportionally to the amount that is supplied to the electrical line system by the first electrical machine.

The output device can essentially be designed as a driven axle or as a wheel of a motor vehicle.

Accordingly, the control device enables mechanical energy of the output device to be converted into electrical energy by the second electrical machine and this electrical energy to be converted, at least proportionally, in turn by the first electrical machine into mechanical energy that is transmitted to the internal combustion engine, wherein the electrical energy is ultimately converted into heat due to friction.

Accordingly, even if the energy store of the motor vehicle is no longer capable of absorbing energy or if the energy store is no longer intended to absorb electrical energy, mechanical energy of the output device or a wheel or several wheels of a motor vehicle equipped with the hybrid drive unit according to the disclosure can be converted efficiently and with little wear, so that a braking effect can be realized on the output device.

According to a further aspect of the disclosure, the electrical line system comprises an electrical storage device for storing electrical energy, which is electrically conductively connected to the first electrical machine and to the second electrical machine.

This electrical storage device, which can also be referred to as a battery or accumulator, forms at least part of the electrical line system between the first electrical machine and the second electrical machine. A respective electrical machine can in particular be connected to the electrical storage device for the transmission of electrical energy via a current conductor.

It is preferably provided that the electrical storage device has a relatively low capacity of 8 to 12 kWh, in particular a capacity of 9 to 11 kWh.

According to a further advantageous embodiment, the electrical line system is designed essentially as an electrical line and directly couples the first electrical machine to the second electrical machine.

According to the disclosure, it should not be ruled out that intermediate pieces, in particular for realizing an electrical connection between the two electrical machines, are implemented in this electrical line. Thus, in this alternative embodiment, no electrical storage device is provided between the two electrical machines in the electrical line system. However, it should also not be ruled out that in addition to this electrical line the electrical storage device is arranged in a parallel current path so that it can be controlled by the control device whether electrical energy generated by an electrical machine or required energy from or to the electrical storage device and electrical energy is conducted from or to an electrical machine from the electrical storage device, or electrical energy generated by an electrical machine is supplied directly to the other electrical machine.

In one embodiment according to the disclosure, the control device is further designed to open the disconnect clutch or to hold it in the open state when a defined braking torque is required on the output device.

By opening or holding the disconnect clutch in an open state, it is possible to use the internal combustion engine independently of the rotational speed of the output device.

According to a further embodiment, the hybrid drive unit further comprises a mechanical braking device, with which a braking torque can also be implemented on the output device.

In this embodiment, the control device is also advantageously designed because it can be used to control the braking effect of the mechanical braking device or the braking effect provided by the second electrical machine, the first electrical machine and the internal combustion engine can be adapted in order to ultimately achieve that of a driver or a cruise control system of the motor vehicle to realize the required braking effect.

The connection device, the first electrical machine, the disconnect clutch, the second electrical machine and the output device are advantageously arranged in series in a common torque transmission path.

In a further embodiment, the control device is designed to vary the generator power of the second electrical machine as a function of the magnitude of the braking torque requirement on the output device.

Accordingly, more electrical energy is also provided for motor operation of the first electrical machine, which accordingly implements a stronger mechanical drive of the connection device or the internal combustion engine and thus ultimately implements an increased braking effect of the output device depending on the braking torque requirement.

It is thus even possible to achieve a greater braking torque on the output device than with a rigid or non-rotatable connection between the output device and the internal combustion engine for the purpose of driving it by the output device.

In a further advantageous embodiment, the control device is designed to operate the second electrical machine in generator mode, to supply electrical energy provided by the second electrical machine to the electrical storage device, to supply electrical energy from the electrical storage device to the first electrical machine and to operate it in motor mode so that the second electrical machine drives the connection device when the charge of the electrical storage device exceeds a defined state of charge.

Accordingly, the control device can only implement the generator and motor mode according to the disclosure when the electrical storage device cannot or should no longer receive electrical energy, such as during or after long downhill travel.

Insofar as the electrical storage device still has the capacity provided for the absorption of electrical energy, a conventional recuperation operation can be carried out in order to convert mechanical energy of the output device into electrical energy, to store it and to make it available later, in particular to drive the motor vehicle.

Furthermore, according to the disclosure, a hybrid drive arrangement of an electrically drivable motor vehicle, in particular a hybrid motor vehicle, is provided, comprising a hybrid drive unit according to the disclosure and an internal combustion engine, the output of which is mechanically coupled to the connection device of the hybrid drive unit.

In addition, according to the disclosure, a method for operating a hybrid drive arrangement is provided in which a hybrid drive arrangement is used and when a braking torque is required on the output device, by means of the control device the second electrical machine is operated in generator mode, electrical energy provided by the second electrical machine is supplied to the electrical line system and electrical energy is supplied from the electrical line system of the first electrical machine, while making at least proportional use of the electrical energy from the electrical line system in motor mode, so that the second electrical machine drives the connection device, by means of which torque is then supplied to the internal combustion engine.

Another aspect of the present disclosure is a computer program, in particular application software, which can be loaded into an internal, in particular non-volatile storage device of a digital computer, in particular a control device of a hybrid drive unit according to the invention, and which comprises a computer program code which—if a digital computer is used—executes at least the steps of:
Establishing a requirement for at least one defined braking torque on the output device, and
Generating a command for operating the second electrical machine in generator mode.

Furthermore, the computer program can optionally also generate a command to transfer electrical energy from the electrical line system to the first electrical machine and/or generate a command to operate the first electrical machine, making at least proportional use of the electrical energy from the electrical line system in motor mode.

Accordingly, the computer program according to the disclosure is designed to carry out at least some steps of the method according to the disclosure or to support them and thus automatically use the drag torque of the second electrical machine to brake the motor vehicle with a defined braking requirement.

In particular, it can be provided that before the step of generating a command for transmitting electrical energy from the electrical line system to the first electrical machine, a query is first made about the state of charge of a storage device in the electrical line system. The computer program can detect a current state of charge of the storage device, compare it with a defined limit state of charge and then generate a command for further action. If the state of charge has reached or possibly exceeded the limit state of charge, the step of generating a command for transmitting electrical energy from the electrical line system to the first electrical machine is carried out. If a limit state of charge has not been reached, charging of the storage device of the electrical line system can first be carried out. A limit state of charge can be a state of the storage device in which no more electrical energy can be absorbed or in which no more electrical energy should be absorbed.

It can be provided that the computer program further defines the amount of electrical energy that is transmitted from the storage device in the electrical line system to the first electrical machine. In particular, the amount of electrical energy transferred from the storage device to the first electrical machine can correspond to the amount of electrical energy that the second electrical machine makes available in generator mode.

### BRIEF DESCRIPTION OF THE DRAWINGS

The disclosure described above is explained in detail below based on the relevant technical background with reference to the associated drawing, which shows a preferred embodiment in detail. The disclosure is in no way restricted by the purely schematic drawing, wherein it should be noted that the exemplary embodiment shown in the drawing is not limited to the dimensions shown. In the drawing:

The single FIGURE shows a schematic representation of a hybrid drive arrangement with a hybrid drive unit according to the disclosure.

### DETAILED DESCRIPTION

In the embodiment of the disclosure shown, the hybrid drive arrangement 2 comprises a hybrid drive unit 1 and an internal combustion engine 9. The hybrid drive unit 1 comprises a first electrical machine 3, a second electrical machine 4, a disconnect clutch 5, an output device 6 and a connection device 13.

These elements of the hybrid drive unit 1 are arranged in series, coaxially to a common axis of rotation 10.

The subject matter of the present disclosure is not limited to this geometric arrangement of the individual elements, but in particular the wheel 6 can be provided by a gear, in particular a gear with a fixed gear ratio, and a differential gear in relation to the electrical machine and/or in relation to the internal combustion engine 9 be arranged in a radially offset position.

An internal combustion engine 9 comprising the hybrid drive arrangement 2 is also arranged coaxially with respect to the common axis of rotation 10.

The connection device 13 non-rotatably connects the first electrical machine 3 and thus the hybrid drive unit 1 to the internal combustion engine 9, wherein the second electrical machine 4 is non-rotatably connected to the output device 6 configured as a wheel of a motor vehicle.

The disconnect clutch 5 is arranged in the axial direction between the two electrical machines 3, 4, the torque transmission path between the second electrical machine 4 or the internal combustion engine 9, wherein by means of the disconnect clutch 5 or closing of the disconnect clutch 5, the torque-transfer path between the second electrical machine 4 or the internal combustion engine 9 and the output device 6 can be closed. For this purpose, the first electrical machine 3 is non-rotatably connected to a first disconnect clutch side 11 and the second electrical machine 4 is non-rotatably connected to a second disconnect clutch side 12.

The two electrical machines 3, 4 are furthermore electrically connected to one another via an electrical line system 7. The electrical line system 7 shown here comprises a storage device 8 and a first and a second electrical line 14, 15. The first electrical machine 3 is connected to the storage device 8 by means of the first electrical line 14 and the second electrical machine 4 is connected to the storage device 8 by means of the second electrical line 15 for the purpose of transmitting electrical energy from an electrical machine 3, 4 to the storage device 8 or from the storage device 8 to an electrical machine 3, 4. The first electrical machine 3 can either be operated in generator mode in order to generate electrical energy while driven by the internal combustion engine 9) and to supply it to the storage device 8, or it can be operated in motor mode in order to use electrical energy from the storage device 8 to transfer torque to the internal combustion engine 9. The second electrical machine 4 can likewise be operated either in generator mode in order to generate electrical energy while driven by the torque transferred from the output device 6 and to supply this to the storage device 8, or in motor mode to obtain electrical energy from the storage device 8 to transmit torque to the output unit 6.

The hybrid drive unit 1 also comprises a control device 16. According to the disclosure, the control device 16 is designed to operate the second electrical machine 4 in generator mode when a braking torque is required on the output device 6, to supply electrical energy provided by the second electrical machine 4 to the electrical line system 7 and to supply electrical energy from the electrical line system 7 to the first electrical machine 3 and to operate it, while making at least proportional use of the electrical energy from the electrical line system 7 in motor mode, so that the second electrical machine 4 drives the connection device 13 or the internal combustion engine 9.

For this purpose, the control device 16 is connected by control devices to the second electrical machine 4 and to the line system 7 for transferring the corresponding commands. A certain command can in particular be generated by, for example, a computer program that can be executed by the control device 16.

When the second electrical machine 4 is operated as a generator, it can also be provided that the electrical energy supplied to the electrical line system 7 first charges the storage device 8. A certain state of charge of the storage device 8, at which the storage device 8 can or should no longer receive electrical energy, can be defined. If the second electrical machine 4 now generates so much electrical energy, for example when traveling downhill for a long time, that its defined state of charge is exceeded or reached when it is supplied to the storage device, the control device 16 carries out the generator and motor modes according to the disclosure of the electrical machines 3 and 4.

In a further embodiment (not shown here) the electrical line system 7 does not comprise an extra storage device 8 but is formed only by electrical conductors, so that the first electrical machine 3 is electrically coupled directly to the second electrical machine 4 and consequently electrical energy provided by the second electrical machine 4 is supplied directly to the first electrical machine.

By means of the design of the hybrid drive unit and hybrid drive arrangement proposed here and the method for operating a hybrid drive arrangement according to the disclosure, the individual elements of the hybrid drive unit according to the disclosure can be used efficiently, in particular with multiple functions, in order to implement optimum driving with a comfortable and reliable driving feel.

### LIST OF REFERENCE NUMBERS

1 Hybrid drive unit
2 Hybrid drive arrangement
3 First electrical machine
4 Second electrical machine
5 Disconnect clutch
6 Output device
7 Electrical line system
8 Storage device
9 Internal combustion engine
10 Axis of rotation
11 First disconnect clutch side
12 Second disconnect clutch side
13 Connection device
14 First electrical line
15 Second electrical line
16 Control device

1. A hybrid drive unit (1) for a drive train of an electrically drivable motor vehicle, in particular a hybrid motor vehicle, having a connection device (13) for mechanically coupling an internal combustion engine (9), a first electrical machine (3), a disconnect clutch (5), a second electrical machine (4), an output device (6), and an electrical line system (7) between the first electrical machine (3) and the second electrical machine (4), as well as a control device (16) which is designed, when a braking torque is required on the output device (6), to operate the second electrical machine (4) in generator mode, to supply electrical energy provided by the second electrical machine (4) to the electrical line system (7) and to supply electrical energy from the electrical line system (7) to the first electrical machine (3) while making at least proportional use of the electrical energy from the electrical line system (7) in motor mode, so that the second electrical machine (4) drives the connection device (13), with which torque can then be supplied to the internal combustion engine (9).

2. The hybrid drive unit (1) according to claim 1,
characterized in that the electrical line system (7) comprises an electrical storage device (8) for storing electrical energy, which is electrically conductively connected to the first electrical machine (3) and to the second electrical machine (4).

3. The hybrid drive unit (1) according to claim 1,
characterized in that the electrical line system (7) is designed essentially as an electrical line (14, 15) and couples the first electrical machine (3) directly to the second electrical machine (4).

4. The hybrid drive unit (1) according to any one of the preceding claims,
characterized in that the control device (16) is further designed to open the disconnect clutch (5) or to maintain it in the open state when a defined braking torque is required on the output device (6).

5. The hybrid drive unit (1) according to any one of the preceding claims,
characterized in that the hybrid drive unit (1) further comprises a mechanical braking device, with which a braking torque can also be implemented on the output device (6).

6. The hybrid drive unit (1) according to any one of the preceding claims,
characterized in that the connection device (13), the first electrical machine (3), the disconnect clutch (5), the second electrical machine (4), and the output device (6) are arranged in series on a common torque transmission path.

7. The hybrid drive unit (1) according to any one of the preceding claims,
characterized in that the control device (16) is designed so as to vary the generating power to the second electrical machine (4) depending on the magnitude of the braking torque requirement on the output device (6).

8. The hybrid drive unit (1) according to any one of claims 2 to 7,
characterized in that the control device (16) is designed to operate the second electrical machine (4) in generator mode, to supply electrical energy provided by the second electrical machine (4) to the electrical storage device (8), to supply electrical energy from the electrical storage device (8) to the first electrical machine (3), and to operate it in motor mode so that the second electrical machine (4) drives the connection device (13) when the charge of the electrical storage device (8) exceeds a defined state of charge.

9. A hybrid drive arrangement (2) of an electrically drivable motor vehicle, in particular a hybrid motor vehicle, comprising a hybrid drive unit (1) according to one of claims 1 to 8 and an internal combustion engine (9), the output of which is mechanically connected to the connection device (13) of the hybrid drive unit (1).

10. A method for operating a hybrid drive arrangement (2) according to claim 9, in which a hybrid drive arrangement (2) according to claim 9 is provided and, when a braking torque is required on the output device (13) by means of the control device (16), the second electrical machine (4) is operated in generator mode, electrical energy provided by the second electrical machine (4) is supplied to the electrical line system (7), and electrical energy is supplied from the electrical line system (7) to the first electrical machine (3), while making at least proportional use of the electrical energy from the electrical line system (7) in motor mode so that the second electrical machine (4) drives the connection device (13), by means of which torque is then supplied to the internal combustion engine (9).
